(19) United States
(12) Patent Application Publication
(10) Pub. No.: US 2024/0374993 A1
(43) Pub. Date: Nov. 14, 2024

(54) System and Method for Calibration and Modification of Game Controller and Peripherals

(71) Applicant: Hercule Engineering LLC, Jessup, MD (US)

(72) Inventor: Andre S. Davis, Jessup, MD (US)

(21) Appl. No.: 18/658,907

(22) Filed: May 8, 2024

Related U.S. Application Data
(60) Provisional application No. 63/464,669, filed on May 8, 2023.

(51) Int. Cl. A63F 13/23

(52) U.S. Cl. CPC A63F 13/23

(57) ABSTRACT

The invention described herein relate to a data processing unit, wherein the data processing unit is configured to: create input and output memory map files; monitor activity of a controller communicatively coupled to the data processing unit, wherein the activity of the controller includes input data; determine a type of controller for the controller based on a first identification value associated with the controller; associate the controller with a second identification value, wherein the second identification value is associated with a first memory location in the input memory; convert the input data of the controller to generic controller data; write the generic controller data to the first memory location in the input memory map based on the second identification value; and continuously monitor the controller via a controller handler.

### CROSS-REFERENCES TO RELATED APPLICATIONS

This application claims the benefit of U.S. Application Ser. No. 63/464,669, filed May 8, 2023, the contents of which are hereby incorporated by reference.

### BACKGROUND OF INVENTION

### Field of the Invention

The present invention relates to a data processing unit that acts as a junction between a video game console and one or more controllers to reduce the latency of game inputs, calibrate one or more game inputs, or convert one or more input devices to a different type of input device. In addition, the data processing unit may connect to a computing device via a Wi-Fi network adapter or Bluetooth to display console controller visualization and simulation that can also be used for training in the video game console's games.

Esports and professional video game events/tournaments are on the rise, both in terms of popularity and accessibility. Players use physical controllers to best one another in a variety of different genres of video games. It should be noted that each one of these events or tournaments involves the use of physical, corporeal controllers by the players to control their character's actions and movements.

Particular genres of video games have a significant following with a player base that deeply understands the mechanics of the game, even unintended mechanics that require very specific inputs on a controller. Certain games may demand particular mechanics that heavily depend on the quality and durability of the controller available to the player. Professional players may be held back by faulty or lacking equipment. Furthermore, certain consoles and games played at the professional level require the use of older or retro versions of controllers, as has been determined by the profession and player base.

Professionals are able to input almost frame-perfect reactions and character actions using their preferred controllers. However, older controllers are inherently more prone to wear and tear as well as technical limitations over time. The tactics and procedures used by professional-level players can deteriorate external and internal hardware components, such as button inputs and analog sticks, as they play.

However, even with a pristine and perfectly operational controller, an Esports athlete or professional may face other issues. One severe issue can be caused by inputting commands with button presses or control stick movements at a speed such that the console cannot keep up with the player's inputs due to a mixture of inferior polling rates and latency.

Furthermore, there is a need for a device that may convert different input types to specific output types, such that different controllers may be used to perform actions in the output device, where the controller type and the output type may or may not match. In addition, there is a need for a device that would allow for virtual controller simulations and visualizations that could reduce physical controller wear and tear by allowing for methods by which players may obtain real data and real simulations pulled from their controllers/inputs without requiring physical input. This would not only allow for better handling and reduced usage of physical controllers but also the ability to allow players to train and simulate play styles, move combinations, and matches with a level of precision that cannot be found on existing consoles or video games' computer matches against artificial intelligence or training modes.

As such, a need exists in the field for novel technology that can solve the issues of controller degradation that are tied along with the issues surrounding controller latency and lack of the ability for the console to properly keep up and understand input commands from players in the competitive gaming and Esports arenas, where even small mistakes in which controller inputs or responses can change the scope of an entire match or tournament. The need exists for a device that can reduce the latency of controller inputs while also increasing the polling rate for the inclusion of additional inputs to allow more accurate gameplay that also reduces wear and tear on vintage and professional-level video game console controllers. Additionally, there is a need for a device that may convert different input types to specific output types, such that different controllers may be used to perform actions in the output device, where the controller type and the output type may or may not match. Finally, there is also a need for a device that can run controller visualization and simulation to reduce the physical loads and burdens on professional-level controllers due to inputs as well as provide opportunities for more optimized and precise digital simulation/training that outpaces currently available methods, modes, and models found internally in individual games.

### SUMMARY OF THE INVENTION

The present invention comprises a novel device, the data processing unit (“the NJM device”), that may run via a quad-core single-board computer running an embedded Linux operating system connected to both a video game console via a micro-USB to USB-A cable and to a controller via one or more USB-A cords, whereby that device may use a special set of USB/HID descriptors to change the video game console's and the controller's polling rates such that the device simultaneously responds to controller data polling requests coming from the video game console so that proxy controller data captures from the controller to the video game console are completed at the lowest possible polling rate compatible with the video game console to traditional inputs captured by the video game console. The novel device further allows for modification of incoming controller data such that the incoming controller data represents a different type of controller and/or acts as a “perfect” controller. The novel device also allows controller visualization and simulation for training purposes. The novel device may utilize an internal webpage server to allow a user to perform the various actions described above.

In some aspects, the techniques described herein relate to a data processing unit, wherein the data processing unit is configured to: create input and output memory map files; monitor activity of a controller communicatively coupled to the data processing unit, wherein the activity of the controller includes input data; determine a type of controller for the controller based on a first identification value associated with the controller; associate the controller with a second identification value, wherein the second identification value is associated with a first memory location in the input memory; convert the input data of the controller to generic controller data; write the generic controller data to the first memory location in the input memory map based on the second identification value; and continuously monitor the controller via a controller handler.

In some aspects, the techniques described herein relate to a data processing unit, wherein the second identification value is derived from a standardized numerical range of second identification values and the first identification value is associated with an identification value provided by a manufacturer of the controller.

In some aspects, the techniques described herein relate to a data processing unit, wherein the data processing unit executes commands via one or more processing threads.

In some aspects, the techniques described herein relate to a data processing unit, wherein each memory map file is partitioned into one or more memory blocks.

In some aspects, the techniques described herein relate to a data processing unit, wherein each memory map file has a size of at least 100 bytes and each memory block has a size of at least 24 bytes.

In some aspects, the techniques described herein relate to a data processing unit, wherein the data processing unit is configured to modify a polling rate of the controller.

In some aspects, the techniques described herein relate to a data processing unit, wherein the input data includes resting state data and active state data.

In some aspects, the techniques described herein relate to a data processing unit, wherein: the resting state data represents a resting state of a controller, wherein the resting state of the controller includes one or more numerical values representing an initial position of one or more controller sticks, a resting pressure of one or more buttons, the resting pressure of one or more triggers, or any combination thereof; and the active state data represents one or more current inputs provided by the controller, wherein the one or more current inputs are associated with values representing pressure and position for the one or more buttons and the one or more triggers and the one or more controller sticks, respectively.

In some aspects, the techniques described herein relate to a method, including: identifying active state data associated with a specific controller of one or more controllers communicatively coupled to a data processing unit via an associated controller handler; retrieving the active state data from the specific controller; converting the active state data into generic controller data based on a type of controller; modifying the generic controller data based on a rule set associated with a selected profile; and write the modified generic controller data to a second memory location in an output memory map.

In some aspects, the techniques described herein relate to a method, wherein the rule set includes a corrective algorithm, a conversion algorithm, a simulation algorithm, or any combination thereof.

In some aspects, the techniques described herein relate to a method, including, when the rule set is the conversion algorithm, modifying the generic controller data such that the generic controller data is compatible with a connected output.

In some aspects, the techniques described herein relate to a method, including associating the second memory location with an identification value, wherein the identification value of the specific controller represents a position in order of the specific controller in the of one or more controllers.

In some aspects, the techniques described herein relate to a method, including, when the rule set is the corrective algorithm, modifying the generic controller data via a function of resting state data, the active state data, and default state data.

In some aspects, the techniques described herein relate to a method, wherein: the resting state data represents a resting state of a controller, wherein the resting state of the controller includes one or more numerical values representing an initial position of one or more controller sticks, a resting pressure of one or more buttons, the resting pressure of one or more triggers, or any combination thereof; the active state data represents one or more current inputs provided by the controller, wherein the one or more current inputs are associated with values representing pressure and position for the one or more buttons and the one or more triggers and the one or more controller sticks, respectively; and the default state data represents a factory state of a controller, wherein one or more values associated with the factory state represent an unused controller.

In some aspects, the techniques described herein relate to a non-transitory computer readable medium having computer-readable instructions stored thereon that are executable by a processor configured to: initialize an output handler based on a connected output; detect a request for output data from the connected output via the output handler; transmit a waking signal to the output handler based on the request; retrieve the output data from an output memory map via the output handler; and transmit the output data to the connected output via the output handler.

In some aspects, the techniques described herein relate to a non-transitory computer readable medium, wherein the processor is configured to automatically determine the connected output based on the detected request from the connected output.

In some aspects, the techniques described herein relate to a non-transitory computer readable medium, wherein the processor is configured to designate one or more processing threads for the output handler.

In some aspects, the techniques described herein relate to a non-transitory computer readable medium, wherein the processor is configured to set a flag to true when the request for output data is detected.

In some aspects, the techniques described herein relate to a non-transitory computer readable medium, wherein the processor is configured to, when the flag is true, continuously proxy the output data from a output memory map file to the connected output.

In some aspects, the techniques described herein relate to a non-transitory computer readable medium, wherein the processor is configured to retrieve the output data from an output memory map via the output handler via an assigned identification value, wherein an assigned identification value points to a location of the output data in the output memory map.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 is a block diagram of a real-time configuration using the data processing unit, in accordance with the present embodiments;

FIG. 2 illustrates a flowchart of a method to process input data received at the data processing unit in accordance with the present embodiments;

FIG. 3 illustrates an example configuration for a memory map file, in accordance with the present embodiments;

FIG. 4 illustrates a flowchart of a method for modifying the input data from an exemplary controller via the data processing unit, in accordance with the present embodiments;

FIG. 5 illustrates a flowchart of a method for transmitting output data via the data processing unit, in accordance with the present embodiments; and

FIG. 6 illustrates a block diagram of a simulation configuration using the data processing unit, in accordance with the present embodiments.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefits, and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details. The present disclosure is to be considered an exemplification of the invention and is not intended to limit the invention to the specific embodiments illustrated by the figures or description below.

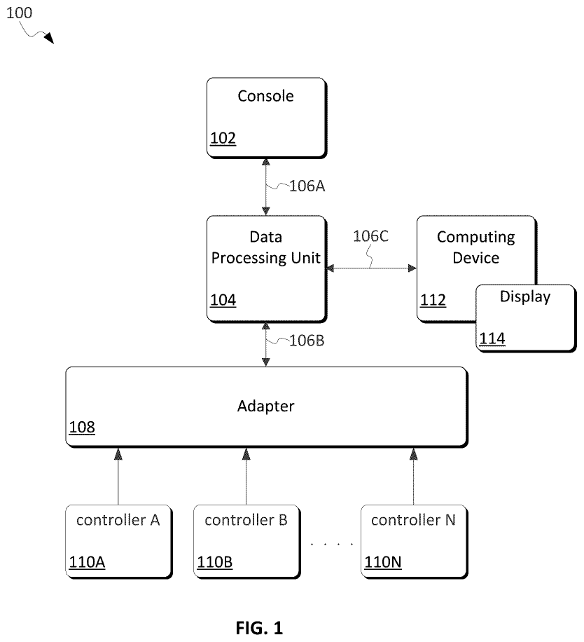

FIG. 1 illustrates a system 100 of a real-time configuration setup of a console 102 communicatively coupled to a data processing unit (the “NJM device”) 104 according to various embodiments of the present invention. The console 102 may be any suitable video game console which utilizes USB/Human Interface Devices to receive and send data. It should be noted that the data processing unit 104 may use alternative connection protocols instead of or accompanying the USB/Human Interface Devices. The data processing unit 104 may include a quad-core single-board computer running an embedded Linux operating system. The data processing unit 104 may use a particular set of USB/Human Interface Devices descriptors to establish Input/Output (I/O) communication and to perform polling rate manipulation. The console 102 communicates with the data processing unit 104 via a connection 106A, where the connection 106A may include a micro-USB to USB-A cable, a USB-A cable to USB-A cable, USB-C cable to USB-A/B cable, or any suitable USB/Human Interface Device connection. Additionally, the connection 106A may be a wireless connection via a local Wi-Fi network and/or Bluetooth. In some embodiments, the data processing unit 104 may be communicatively coupled to an adapter 108 via a connection 106B, where the connection 106B may include a micro-USB to USB-A cable, a USB-A cable to USB-A cable, or any suitable USB/Human Interface Device connection. Additionally, the connection 106B may be a wireless connection via a local Wi-Fi network and/or Bluetooth. In some embodiments, the adapter 108 may be a USB hub for multiple USB-enabled controllers 110 to connect simultaneously to the data processing unit 104 via the adapter 108.

The adapter 108 may further be connected to one or more controllers 110 (e.g., controller 110A, controller 110B, . . . controller 110N). The one or more controllers 110 may be any wired USB-enabled video game controller that provides complementary controller data, including, but not limited to, a Nintendo Switch Controller, a GameCube controller, any generation of Xbox controller, any generation of PlayStation controller, or any third-party controller. In some embodiments, the one or more controllers 110 may be replaced by or used in concurrence (as another controller) with one or more sets of a keyboard and mouse. With this in mind, the adapter 108 may be used to connect particular controllers 110 to the data processing unit 104. By way of example, in the case that the controllers 110 are GameCube controllers, then the data processing device 104 may use an appropriate adapter 108 to properly receive data from the one or more controllers 110. In another example, a four USB hub may act as the adapter 108 and serve to connect USB-enabled controllers to the data processing unit 104 (e.g., Xbox, PlayStation controllers, mouse and keyboard, etc.). It should be noted that, in some embodiments, the data processing unit 104 may connect directly to the controller(s) 110 without the adapter 108.

Further, the data processing unit 104 is communicatively connected to the computing device 112 via a connection 106C. The connection 106C may be any suitable USB/Human Interface Device connection. In some embodiments, the data processing unit 104 may connect to the computing device 112 via a local Wi-Fi network, a Bluetooth connection, or both. It should be noted that the computing device 112 may be a laptop, desktop computer, a mobile phone, or any other device with the resources sufficient to access the data processing unit 104. In exemplary embodiments, the computing device 112 may preferably operate with either a dual-core computer with a CPU greater than or equal to 2 GHz or a quad-core computer with at least 1.5 GHz of CPU and greater than 2 GB of RAM. The computing device 112 may connect to the data processing unit 104 to access embedded webpages hosted on the data processing unit 104 to send and receive data from the data processing unit 104. The computing device 112 may include a display 114, where the display 114 may be integrated into the computing device 112 and/or a external display. The computing device 112 may display a user interface (“UI”) on the display 114 once connected with the data processing unit 104. The data processing unit 104 may be controlled via the UI via the embedded webpages, where a user may convert the input data from the one or more controllers 110 to any compatible output data, visualize real-time inputs live inputs or in a log format (e.g., last 50 inputs visualized), record and playback inputs, create scenarios by instruction the data processing unit 104 to wait for specific input sequences and reacting with a simulated response, randomize complex controller playback, and any other additional commands available.

The data processing unit 104 may modify the polling rate of both console 102 and the controller(s) 110 to receive and/or transmit data at a higher or a lower polling rate. The data processing unit 104 may use a higher or lower polling rate to receive data from the controller 110 based on compatible polling rate speeds of the console 102. By way of example, the data processing unit 104 uses a special set of USB/Human Interface Devices 106 descriptors to change the console's 102 USB polling rate to the lowest possible polling rate (e.g., 1 ms, 4 ms, etc.) compatible with the console and change the polling rate of a particular controller 110 to match the console 102. The data processing unit 104 may operate concurrently in response to both connected systems, the console 102 and the particular controller 110. In other embodiments, the data processing unit 104 may both connect directly to one or more controller(s) 110 and to the adapter 108. It should be noted that the data processing unit 104 may perform polling modification when a specific controller 110 and/or the connected output are compatible with polling modification.

The data processing unit 104 may generate its own ad hoc Wi-Fi network. That is, the data processing unit 104 may be connected via a private or public Wi-Fi Network, a direct connection to the data processing unit 104 ad hoc Wi-Fi network, a Bluetooth device that is capable of passing on inputs compatible with the data processing unit 104, or any combination thereof. In other embodiments, the data processing unit 104 may integrate with one or more web sockets to accept inputs and to enable custom controllers.

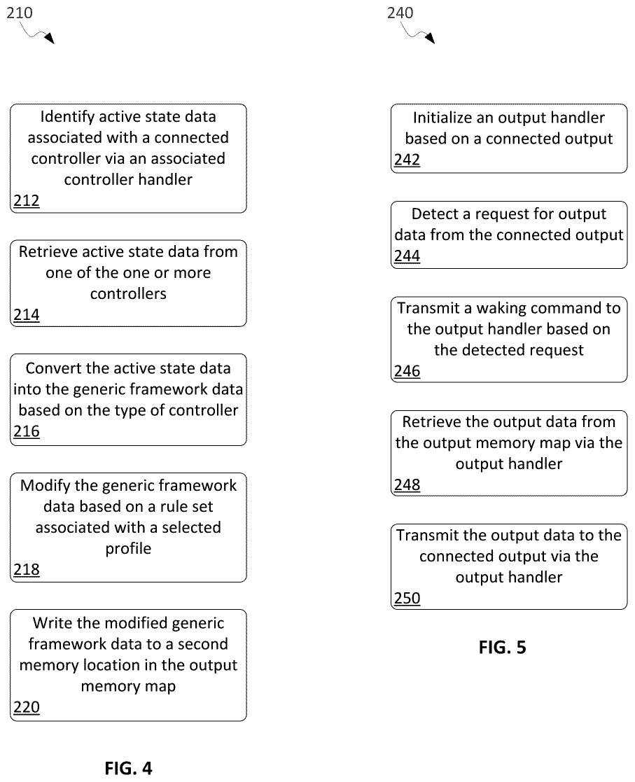

The data processing unit 104 may create and manage profiles on the computing device 112, where each profile may be associated with one or more selected controllers 110 of the one or more controllers 110. The one or more profiles may be displayed on the display 114 of the computing unit 112. Each profile may include instructions to modify the data from the one or more controllers 110 based on a particular outcome and further addressed in FIG. 4. Profiles, when selected, may be made immediately active for a particular controller(s) 110.

It should be noted that the data processing unit 104 may initialize a local web server (e.g., dotnet/mono C# ASP.net) to enable management of the one or more processes executed by the data processing unit 104. As discussed above, the data processing unit 104 may generate an ad hoc Wi-Fi connection to allow for users to connect to the data processing unit 104. In some embodiments, the user may use their mobile device and/or computing device 112 to connect to the ad hoc Wi-Fi to connect the data processing unit 104 to the same network that the mobile device and/or computing device 112 is on. The web server may create one or more processing threads and assign each of the one or more processing threads to handle different processes. It should be noted that each processing thread may run concurrently without conflict, due to the minimal interaction between threads. Additionally, a user may access the data processing unit 104 via one or more webpages associated with the local web server. These webpages may allow for users to create their own custom controllers out of compatible devices (e.g., a smartphone, computer, or tablet).

The data processing unit 104 may designate particular threads with different levels of priority. By way of example, the data processing unit 104 may designate one of the one or more processing threads as a main thread, which may handle processes that are intensive and/or time sensitive. These processes are considered higher priority and may include, but are not limited to, gathering generic input data from a memory file in the memory map associated with the one or more controllers 110, converting the generic input data into modified output data, recording inputs, saving recorded inputs to memory, playback of the recorded inputs, waiting for specific actions on a controller and responding by playback of a previously recorded input file, and/or randomizing multiple recorded input files and playback the recorded inputs of one of the recorded files randomly and/or purposefully.

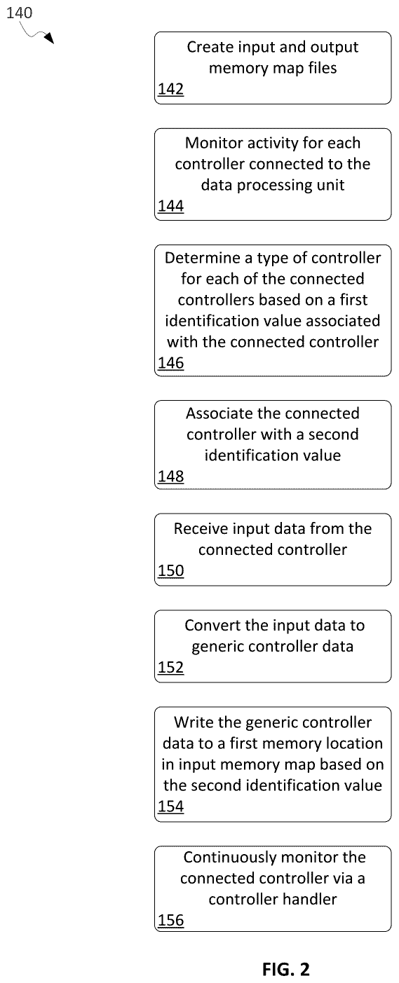

With this in mind, FIG. 2 is a flowchart of a method 140 for processing input data received at the data processing unit 104. Any suitable device (e.g., a controller) that may control components of the data processing unit 104, such as a processor, may perform the method 140. In some embodiments, the method 140 may be implemented by executing instructions stored in a tangible, non-transitory, computer-readable medium. For example, the method 140 may be performed at least in part by one or more software components, such as an operating system, one or more software applications, and the like, of the data processing unit 104. While the method 140 is described using steps in a specific sequence, it should be understood that the present disclosure contemplates that the described steps may be performed in different sequences than the sequence illustrated, and certain described steps may be skipped or not performed altogether.

It should be noted that the method 140 is described from the point of view of the data processing device 104. While the following description of method 140 is described in relation to one or more steps occurring subsequently, it should be understood that each step in the method 140 may occur simultaneously with one another, as will be described further below.

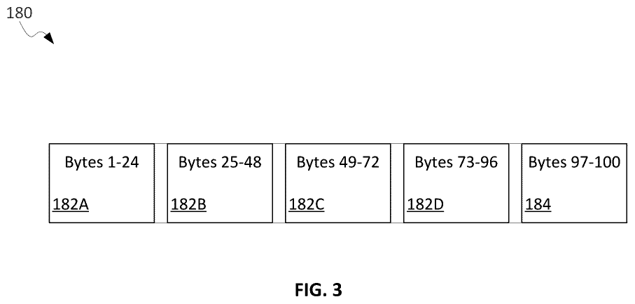

At block 142, the data processing unit 104 may create an input and an output memory map file. The data processing unit 104 may create each memory map file based on compatible controllers, compatible consoles, available memory, manual inputs, or any combination thereof. The structure of the memory map file is explained below with reference to FIG. 3. In some embodiments, each memory map file may have a size of 100 bytes, with the possibility of the size increasing to compensate for new data.

At block 144, the data processing unit 104 may monitor activity from each controller 110 connected to the data processing unit 104. The data processing unit 104 may also detect when each controller 110 is disconnected from the data processing unit 104. At block 146, the data processing unit 104 may determine a type of controller 110 for each of the connected controller(s) 110 based on a first identification value associated with each connected controller 110. The first identification value may be provided by the vendor of each controller 110 and particular vendors may have similar markers in the identification values for each type of controller associated with the vendor (e.g., Sony's PS4 and PS5 controllers). To determine the type of controller 110, the data processing unit 104 may parse through a database of vendor identification values to match one with the first identification value. In some embodiments, the adapter 108 may provide the type of controller(s) 110 connected automatically.

At block 148, the datapo processing unit 104 may associate each connected controller 110 with a second identification value. That is, the data processing unit 104 may assign the second identification value to each connected controller such that the second identification value may include information that describes the type of controller 110 and the controller 110 position in a group of connected controllers 110. The data processing unit 104 may assign a standardized numerical range of second identification values to each connected controller 110.

At block 150, the data processing unit 104 may receive input data from the connected controller. The input data may include resting state data and active state data associated with the controller 110. The resting state data may refer to the resting state, as described by X-axis and Y-axis coordinates, of the one or more controller sticks on the controller 110. The resting state data may include one or more trigger values, which indicate the pressure downwards on the one or more triggers present on the controller 110. The resting state data may also include the resting state of one or more buttons, which indicate the pressure downward on the buttons on the controller 110. The resting state data may be represented as a numerical value (e.g., a number between 0-128/127, 0-255, etc.).

The active state data is the data from the controller 110 that represents current inputs provided by a player using the controller 110. This may include inputs associated with buttons, a directional pad, triggers, coordinates for thumb stick movement, and any other additional inputs provided by the controller 110. It should be noted that the active state data and resting state data may not be encrypted or hidden.

At block 152, the data processing unit 104 may convert the input data into generic controller data. To accomplish this, the data processing unit 104 may initialize one or more specific controller handlers, where each specific controller handler is configured to extract and compress input data representing different types of inputs (e.g., buttons, triggers, etc.) into the generic controller data. Each controller handler may use specific actions to convert the input data based on the type of the controller 110. For example, different controllers 110 produce input data that may have different byte configurations and/or byte lengths. The conversion between input data to generic controller data may be done for every controller 110 connected to the data processing unit 104. In some embodiments, the data processing unit 104 may receive input data from a custom controller that adheres to the same standard as the generic controller data. In this case, there is no specific controller handler to compress the data.

At block 154, the data processing unit 104 may write the generic controller data into a first memory location in the input memory map based on the second identification value. As discussed above, the input memory map may include specific locations for the generic controller data associated with particular types of controllers to be stored. This may be identified via the second identification value, which a user may use to manually find the generic controller data in the input memory map.

At block 156, the data processing unit 104 may continuously monitor each controller 110 via the controller handler. Each controller handler may check for new input data from its respective controller 110, convert the new input data to generic controller data, and write the generic controller data into the proper location in the input memory map. When the controller handler detects that its associated controller 110 has encountered an error or it was disconnected from the data processing unit 104, the controller handler may delete any associated metadata and terminate its processing thread. It should be noted that each controller handler may utilize one or more processing threads from the web server discussed above.

As discussed above, the data processing unit 104 may create the memory map file for both input and output data. With the foregoing in mind, FIG. 3 illustrates an example configuration for a memory map file 180. It should be noted while the memory map file 180 is described as being sized at 100 bytes, this should not be considered limiting and the byte size of the memory map file may increase to accommodate more data. The memory map file 180 has one or more memory blocks 182 (e.g., memory block 182A, memory block 182B, memory block 182C, memory block 182D) where each memory block 182 may be assigned to a specific controller 110. Each of the one or more memory blocks 182 may have a size of 24 bytes. The data processing unit 104 may store the generic controller data in bytes 0-15 and may reserve bytes 16-24 for future development. Furthermore, the data processing unit 104 may reserve the last four bytes of the memory map file 180 to represent which type(s) of controller(s) 110 are currently connected. That is, a high value in bit 97-100 may indicate that a particular type of controller is connected. For example, a high value at byte 97 may indicate that a first type of controller (e.g., a Xbox controller) is connected and a high value at byte 99 may indicate that a second type of controller (e.g., a custom controller) is connected. This is to communicate to the data processing unit 104 to ensure that the correct output is provided.

Once the controller(s) 110 are detected and the input data of each of the controller(s) is converted into generic controller data and stored in a corresponding memory block 182 in an input memory map file, the data processing unit 104 may continue to monitor new input data and modify the generic controller data that is sourced from the new input data.

With the foregoing in mind, FIG. 4 illustrates a method 210 for modifying the input data from an exemplary controller 110 via the data processing unit 104. Any suitable device (e.g., a controller) that may control components of the data processing unit 104, such as a processor, may perform the method 210. In some embodiments, the method 210 may be implemented by executing instructions stored in a tangible, non-transitory, computer-readable medium. For example, the method 210 may be performed at least in part by one or more software components, such as an operating system, one or more software applications, and the like, of the data processing unit 104. While the method 210 is described using steps in a specific sequence, it should be understood that the present disclosure contemplates that the described steps may be performed in different sequences than the sequence illustrated, and certain described steps may be skipped or not performed altogether.

It should be noted that the method 210 is described from the point of view of the data processing device 104. While the following description of method 210 is described in relation to one or more steps occurring subsequently, it should be understood that each step in the method 210 may occur simultaneously with one another, as will be described further below.

The data processing unit 104 may use the main processing thread to carry out the method 210, since the data processing unit 104 may designate the method 210 as a high priority task. With this in mind, at block 212, the data processing unit 104 may identify active state data associated with a specific controller via the corresponding controller handler. As discussed above, the active state data of each controller 110 may represent current inputs provided by a user using the controller 110. To identify active state data, the data processing unit 104 may loop through each of the connected controller(s) 110 and read the associated memory map file associated with each controller 110. When active state data is detected, the data processing unit 104 may communicate with the corresponding controller handler.

At block 214, the data processing unit 104 may retrieve the active state data from the specific controller 110. As discussed above, this may include inputs associated with buttons, a directional pad, triggers, coordinates for thumb stick movement, and any other additional inputs provided by the controller 110. It should be noted that the active state data may not be encrypted or hidden. At block 216, the data processing unit 104 may convert the active state data into generic controller data. As discussed above with reference to FIG. 2, the data processing unit 104 may utilize the specific controller handlers to translate the active state data into generic controller data. The generic controller data is stored in the input memory map file based on the second identification code associated with the controller 110. Additionally, the data processing unit 104 may remove any generic controller data associated with one or more disabled inputs.

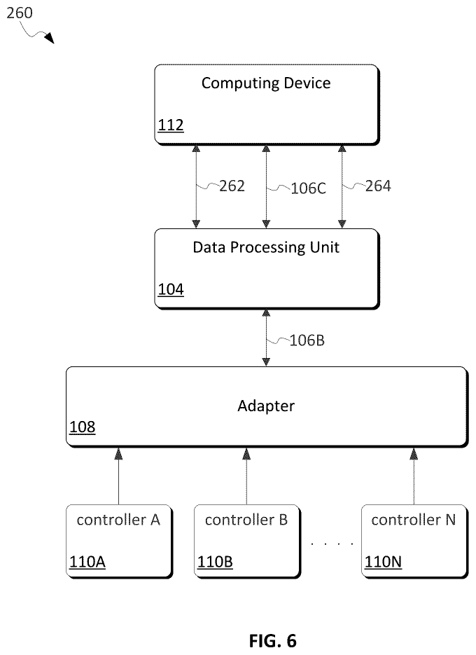

At block 218, the data processing unit 104 may modify the generic controller data based on a rule set associated with the selected profile. Each profile may be associated with a particular controller 110 and include instructions to modify the generic controller data based on a selected rule set. The data processing unit 104 may set the rule set as, but not limited to, a corrective algorithm, a conversion algorithm, a simulation algorithm, or any other suitable algorithm that modifies the generic controller data. While the simulation algorithm will be discussed further with reference to FIG. 6, the corrective algorithm and conversion algorithm will be discussed below.

The data processing unit 104 may use the corrective algorithm as the rule set by applying the corrective algorithm to the state values of detected thumb stick(s) and trigger(s) from the most recent generic controller data received by the data processing unit 104. The correction algorithm considers the resting values of the X-axis and Y-axis of each thumb stick for a particular controller 110 to calculate the newly calibrated inputs, with the current input being equal to a positive sum of a default state value of the stick or trigger minus the resting state value data of the measured item. That is, the default state values of components of the controller 110 refers to the default settings of the controller 110 such that each input is considered “perfect” in the view of the console 102. This is usually associated with state values from unused controllers. As such, the data processing unit 104 may calibrate the generic controller data when the default state value has greater values greater in some intensity/movement than the resting state data values. Additionally, the data processing unit 104 may generate faux input data representing a number of inputs from the controllers 110 such that the data processing unit 104 may ensure that the modified data is interpreted by the console 102 as coming from a correctly aligned controller 110.

Furthermore, the data processing unit 104 may use the conversion algorithm to convert the generic controller data into a desired type of output data. Due to the consistency of the generic controller data, the data processing unit 104 is able to modify the generic controller data to match any compatible output. Each specific controller handler may include code that is designed to convert the generic controller data into output data for a type of controller. It should be noted that the controller handlers represent specific processes being operated via the one or more processing threads. The selected profile may indicate to the data processing unit 104 the type of controller requested. In some embodiments, the data processing unit 104 may modify the generic controller data associated with a first controller 110 (e.g., an Xbox controller) to match the output data expected from a second type of controller 110 (e.g., a XINPUT controller). The generic controller data may be converted into output data representing any compatible controller to another compatible controller, wherein the compatible controllers include video game controllers, keyboard and mouse, unique peripheral input devices, and any other compatible input device.

In one embodiment, the data processing unit 104 may convert a single input device, such as a keyboard and mouse, into one or more input devices. That is, the data processing unit 104 may assign inputs from particular keys on a keyboard to one or more users. A first user may use a first set of inputs on the single input device to represent inputs associated with the first user and a second user may use a second set of inputs on the single input device to represent inputs associated with the second user. In some embodiments, the data processing unit 104 may convert one or more input devices, such as one or more controllers 110, to a single output device. That is, the first user may control a first set of controls that represent a first portion of the single output device and the second user may control a second set of controls that represent a second portion of the single output device. Furthermore, the data processing unit 104 may convert one or more input devices, such as one or more controllers 110, to multiple output devices. has one or more virtual outputs associated with one or more input devices.

At block 220, the data processing unit 104 may write the modified generic controller data to a second memory location in an output memory map. The data processing unit 104 may associate the second memory location in the output memory map with a third identification value. In other embodiments, the second memory location may be associated with the associated controller's 110 position in a set-up of multiple controllers 110 (e.g., first player, second player, etc.).

With the foregoing in mind, FIG. 5 illustrates a method 240 for transmitting output data via the data processing unit 104. Any suitable device (e.g., a controller) that may control components of the data processing unit 104, such as a processor, may perform the method 240. In some embodiments, the method 240 may be implemented by executing instructions stored in a tangible, non-transitory, computer-readable medium. For example, the method 240 may be performed at least in part by one or more software components, such as an operating system, one or more software applications, and the like, of the data processing unit 104. While the method 240 is described using steps in a specific sequence, it should be understood that the present disclosure contemplates that the described steps may be performed in different sequences than the sequence illustrated, and certain described steps may be skipped or not performed altogether.

It should be noted that the method 240 is described from the point of view of the data processing device 104. While the following description of method 240 is described in relation to one or more steps occurring subsequently, it should be understood that each step in the method 240 may occur simultaneously with one another, as will be described further below.

At block 242, the data processing unit 104 may initialize an output handler based on a connected output. The data processing unit 104 may detect the connected output and the type of output data that it utilizes. In some embodiments, a user may manually enter in the type of output device into the data processing unit 104 via a specific webpage. The data processing unit 104 may initiate specific output handlers based on the requested output type and transmit the output data to the connected console. The data processing unit 104 may run one of the specific output handlers at a time, depending on the output type. By way of example, when the output type of the connected output is changed to a different output type, the specific output handler that corresponds with the original input is terminated and a new thread running a new output handler for the new output type is initialized.

At block 244, the data processing unit 104 may detect an output request for the output data from the connected output. The data processing unit 104 may continuously monitor output connections to determine when a new connected device is plugged in. When the new connected device sends a request for the output data, the data processing unit 104 may change the value of a flag designating if there is a connected output to true. At block 246, the data processing unit 104 may transmit a waking command to a specific output handler based on the output request and the output type of connected output. In other embodiments, the output handler may detect the change in the value of the flag for the connected output from false to true. When the change is detected by the output handler, the output handler may wake up.

At block 248, the data processing unit 104 may retrieve the output data from the output memory map file via the output handler. The output handler may use the third identification value and/or the controller's position within the list of active controllers 110 to determine the location of the output data. At block 250, the data processing unit 104 may transmit the output data to the connected output via the output handler. For as long as the connected device flag is true, the output handler may continuously proxy the output data from the output memory map file to the connected device.

In other embodiments, the data processing unit 104 may allow for controller visualization and simulation. With the foregoing in mind, FIG. 6 illustrates a block diagram 260 of a simulation configuration of the data processing unit 104. As discussed above, to perform the controller visualization and simulation operations, the data processing unit 104 is communicatively connected to the computing device 112 via a Wi-Fi network Adapter 262, or Bluetooth receiver 264, or the connection 106C. It should be noted that the computing device 112 may be a laptop or desktop computer. In exemplary embodiments, the computing device 112 may preferably operate with either a dual-core computer with a CPU greater than or equal to 2 GHz or a quad-core computer with at least 1.5 GHz of CPU and greater than 2 GB of RAM. The computing device 112 may connect to the data processing unit 104 to access embedded webpages hosted on the data processing unit 104 to send and receive data from the data processing unit 104.

The computing device 112 may send a command to the data processing unit 104 requesting the inputs of the controller 110 be recorded while the data processing unit 104 may continuously send controller data, including input simulations, controller triggers, and input simulation randomizations based on the computing device's 112 simulation package structure to the computing device 112. The input data from the controller 110 may be sent to the computing device 112 at a particular interval of time (e.g., 8 milliseconds) while the data processing unit 104 requests input data from the controller 110 via polling requests.

The computing device 112 may display input visualizers, which are near real-time demonstrations of inputs from the controller 110, as well as the current position of each thumb stick via the user interface in the embedded web pages via the display 114. The computing device 112 additionally may perform a controller simulation, which allows users to define a sequence of simulated inputs on the controller 110, with the time of each input defined in 0.5 frame measurements. These simulations may be saved, replayed, changed, and recorded on the computing device 112 and/or in the data processing unit 104. Inputs may be recorded wirelessly through a virtual controller or manually with physical controllers.

The data processing unit 104 may include internal code (e.g., firmware, software, or both) and data tables including relevant data structures for the control sets, the feature sets, and the profiles. Each profile may include a name for the profile, a descriptor of the input type (e.g., a “enum” value), a descriptor of the output type, switching instructions, and a selected rule set. A particular profile, both in a modified and/or default state, may be cloned so that a user can edit it. The rule sets, as described above, include the description of different buttons, bumpers, trigger values, and other relevant controller data and how they are modified by applying a particular rule set. A user may designate multiple different buttons, bumpers, and/or triggers to correspond to a particular output button/bumper/trigger combination for the type of output of the connected output.

In embodiments, the data processing unit 104 may display input visualizers. Input visualizers are near real-time demonstrations of which inputs, buttons, and triggers are being pressed, as well as the current position of each thumb stick for the controller connected to the data processing unit 104. When the input visualizers are activated, the computing device 112 may connect to the data processing unit 104 via Wi-Fi SSID. The input visualizers may utilize Server Side Events (SSE) to quickly and efficiently transmit input data to the user interface. The computing device 112 may request the data processing unit 104 to continuously send the controller 104 input data. This data is used to update the display 114 in real time. The graph is 256 display units by 256 display units and may graph each possible X/Y coordinate theoretically possible. By way of example, GameCube controllers produce values between 0-255 for both axis values and both thumb sticks. The control stick visual may be depicted as a white circle with a gray surrounding it, and that is a visual depiction of the exact position the left thumb stick is currently pointing to. This tool manually defines which X-axis and Y-axis coordinates a user wants to input or simulate, either from manual controller inputs, virtual controller inputs, or even mouse inputs representing selected axis points in the control stick visual. An animated controller illustrates which buttons/triggers are currently being pressed by the controller 110, while animated thumb sticks also emulate movement in the same direction that the control sticks are being moved on the controller 110. Preset thresholds may be used to determine how much movement in any particular direction triggers the animated depiction to change. Triggers are user-described events. A trigger is a request for the data processing unit 104 to wait until a specific selection of inputs from the controller 110 is detected. These inputs may be buttons, pressure thresholds, and even thumb stick thresholds defined per unit in the X-axis and Y-axis. In addition, randomizations, which are two or more simulations, have some assigned probability that they may be activated by the device as determined via random number generation, which, if any, simulation path is executed. These randomized responses may be additional simulations or triggers. In addition, scenarios are made up of two or more elements, such as simulations, randomizations, or triggers, and are displayed in a tree node format. As with other aspects of input visualization, scenarios, and randomizations may be simulated, saved, loaded, and edited.

In an embodiment, the controller simulator and input visualizer are tools to help users craft simulation requests for the data processing unit 104 to execute any number of times. These may be a single event, an event repeated a finite number of times, or infinite events. Every graph, diagram, and depiction of all inputs are a binary-defined simulation request. Every element described has a binary equivalent. The data processing unit 104 may display a simulation web page that allows a user to define simulations manually. There is a row that represents each unique set of actions that make up the full simulation. Additionally, there is recording functionality that allows a user to use the controller 110 to record inputs. The recorded inputs may displayed, saved, and loaded at anytime by the user in the webpage.

In an embodiment, the data processing unit 104 may further provide an online cloud-based tool grants a user access to a library of pre-made simulations that may be combined to create a simulation module. A simulation module is a list of simulations put together in a specific order, and each training module lists an author, description, and other forms of metadata. The data processing unit 104 training mode is an extension of the controller simulator. The controller simulator produces the simulations, triggers, randomizations, scenarios, and stories used via the training mode. Simulation modules are static playback of recorded/generated inputs. The data processing unit 104 may monitor one or more controllers 110N by themselves or while recording is occurring. The data processing unit 104 may monitor a particular controller for a specific action (defined the same way rules are in the Controller Profile) and a specific reaction is assigned when the specific action occurs. The data processing unit 104 may monitor more than one controller 110 concurrently. These elements may be combined, given a description, assigned one or more static categories or a user-defined category (a.k.a. as a tag), and uploaded to the cloud-based system. The data processing unit 104 allows users to access all the simulation mode elements contributed by the community and professional content creators, including playlist creation and simulating the playlist in a specific order.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the prospective claims.

What is claimed is:

1. A data processing unit, wherein the data processing unit is configured to:
create input and output memory map files;
monitor activity of a controller communicatively coupled to the data processing unit, wherein the activity of the controller comprises input data;
determine a type of controller for the controller based on a first identification value associated with the controller;
associate the controller with a second identification value, wherein the second identification value is associated with a first memory location in the input memory;
convert the input data of the controller to generic controller data;
write the generic controller data to the first memory location in the input memory map based on the second identification value; and
continuously monitor the controller via a controller handler.

2. The data processing unit of claim 1, wherein the second identification value is derived from a standardized numerical range of second identification values and the first identification value is associated with an identification value provided by a manufacturer of the controller.

3. The data processing unit of claim 1, wherein the data processing unit executes commands via one or more processing threads.

4. The data processing unit of claim 1, wherein each memory map file is partitioned into one or more memory blocks.

5. The data processing unit of claim 4, wherein each memory map file has a size of at least 100 bytes and each memory block has a size of at least 24 bytes.

6. The data processing unit of claim 1, wherein the data processing unit is configured to modify a polling rate of the controller.

7. The data processing unit of claim 1, wherein the input data comprises resting state data and active state data.

8. The data processing unit of claim 7, wherein:
the resting state data represents a resting state of a controller, wherein the resting state of the controller comprises one or more numerical values representing an initial position of one or more controller sticks, a resting pressure of one or more buttons, the resting pressure of one or more triggers, or any combination thereof; and
the active state data represents one or more current inputs provided by the controller, wherein the one or more current inputs are associated with values representing pressure and position for the one or more buttons and the one or more triggers and the one or more controller sticks, respectively.

9. A method, comprising:
identifying active state data associated with a specific controller of one or more controllers communicatively coupled to a data processing unit via an associated controller handler;
retrieving the active state data from the specific controller;
converting the active state data into generic controller data based on a type of controller;
modifying the generic controller data based on a rule set associated with a selected profile; and
write the modified generic controller data to a second memory location in an output memory map.

10. The method of claim 9, wherein the rule set comprises a corrective algorithm, a conversion algorithm, a simulation algorithm, or any combination thereof.

11. The method of claim 10, comprising, when the rule set is the conversion algorithm, modifying the generic controller data such that the generic controller data is compatible with a connected output.

12. The method of claim 9, comprising associating the second memory location with an identification value, wherein the identification value of the specific controller represents a position in order of the specific controller in the of one or more controllers.

13. The method of claim 10, comprising, when the rule set is the corrective algorithm, modifying the generic controller data via a function of resting state data, the active state data, and default state data.

14. The method of claim 13, wherein:
the resting state data represents a resting state of a controller, wherein the resting state of the controller comprises one or more numerical values representing an initial position of one or more controller sticks, a resting pressure of one or more buttons, the resting pressure of one or more triggers, or any combination thereof;
the active state data represents one or more current inputs provided by the controller, wherein the one or more current inputs are associated with values representing pressure and position for the one or more buttons and the one or more triggers and the one or more controller sticks, respectively; and
the default state data represents a factory state of a controller, wherein one or more values associated with the factory state represent an unused controller.

15. A non-transitory computer readable medium having computer-readable instructions stored thereon that are executable by a processor configured to:
initialize an output handler based on a connected output;
detect a request for output data from the connected output via the output handler;
transmit a waking signal to the output handler based on the request;
retrieve the output data from an output memory map via the output handler; and
transmit the output data to the connected output via the output handler.

16. The non-transitory computer readable medium of claim 15, wherein the processor is configured to automatically determine the connected output based on the detected request from the connected output.

17. The non-transitory computer readable medium of claim 15, wherein the processor is configured to designate one or more processing threads for the output handler.

18. The non-transitory computer readable medium of claim 15, wherein the processor is configured to set a flag to true when the request for output data is detected.

19. The non-transitory computer readable medium of claim 18, wherein the processor is configured to, when the flag is true, continuously proxy the output data from a output memory map file to the connected output.

20. The non-transitory computer readable medium of claim 15, wherein the processor is configured to retrieve the output data from an output memory map via the output handler via an assigned identification value, wherein an assigned identification value points to a location of the output data in the output memory map.
